(19) United States
(12) Patent Application Publication
(10) Pub. No.: US 2005/0111156 A1
(43) Pub. Date: May 26, 2005

(54) Continuous status indicator for electrical protection device

(75) Inventor: Kewal K. Chopra, Sterling Heights, MI (US)

Correspondence Address: U.S. ARMY TACOM;ATTN: AMSTA-LP/281, 6501 E. 11 MILE RD., WARREN, MI, 48397-5000, US

(73) Assignee: The United States of America as represented by the Secretary of the Army, Washington, DC (US)

(21) Appl. No.: 10/719,262

(22) Filed: Nov. 24, 2003

(51) Int. Cl. H02H 1/00

(52) U.S. Cl. 361/118

(57) ABSTRACT

This invention is a continuous visual indicator circuit to monitor the status of an electrical protection device that has been located within an electrical circuit, between a power source and an electrical load, to avoid current overload. My indicator circuit is comprised of a series resistor, a light emitting diode, and ground, in that order, which are electrically connected in series. In operation, the indicator circuit is positioned within said electrical circuit at a junction between the electrical protection device and the electrical load. When the electrical protection device is performing its intended, protective function; the light emitting diode of my indicator circuit will be illuminated. If said protective device has failed, then the diode will not be illuminated. These illumination arrangements are intuitive and easily understood by the general public.

### GOVERNMENT INTEREST

The invention described herein may be made, used, and licensed by, or for, the United States Government for governmental purposes without paying me any royalty.

### BACKGROUND AND SUMMARY

This invention pertains to a continuous visual indicator to monitor the status of an electrical protection device (EPD) that has been located within an electrical circuit to prevent current overload. Also provided herein is a ready means for visual detection of whether an EPD is performing its intended, protective function. In those instances where the EPD has opened (failed), my visual indicator (light emitting diode) will not be illuminated. If the EPD is closed (sound or intact), my visual indicator will be illuminated and visible. The general public will find these arrangements are intuitive, easily understood, and accepted. The term EPD as used herein includes circuit breakers, automotive fuses, screw-in fuses, cartridge protective device, and the like. My visual indicators are also incorporated easily into either direct or alternating current systems.

EPDs provide protection in modern electrical circuits to prevent a variety of unsafe electrical conditions, such as current shorts, faults, overloads, and even fires. Normally, circuit designers of electrical systems will position an EPD at a point within the circuit that is between a power source and an electrical load. This arrangement will protect both the circuit and all of its specialized components. As used herein, an electrical load may be utilized to drive a device selected from the group of operating devices consisting of: an electrical, mechanical, or electro-mechanical device.

Present day electrical systems of industrial sites; homes; businesses; and air, ground, or water transports are normally composed of a multiplicity of complex, EPD-protected circuits. In operation, if a short or current spike occurs that will exceed an EPD's rating; the EPD will then fail and thereby interrupt current flow until it is either reset or replaced. Manual inspection of the open circuit is then necessitated to find which EPD(s) have failed or blown. During this time, the electrical service to the affected circuit is terminated, and the intended function of said circuit is impaired or halted. Such a situation needs to be efficiently dealt with to keep the electrical system on-line.

In the past, the absence of visual indicators has consumed considerable time and effort to manually test, by trial and error techniques, one or more of the EPDs present within an electrical system to determine which EPD is open. Moreover, since most EPDs are typically centralized in service panels that are isolated in remote locations under reduced lighting conditions; such an effort has traditionally been a tedious and/or treacherous task to perform.

The less than desirable situations presented above are further exacerbated when the affected electrical circuit is a critical part of a much larger integrated system, such as a military installation; a weapons system or combat transport vehicle; a public safety facility, such as a prison, police station, or fire hall; and/or a health care facility with life-support equipment therein. Since these power requirements are unique, and do not likely allow considerable time to solve these problems; severe injury or death may be an expectable result.

To solve this problem, several inventors have proposed to incorporate with EPDs a variety of visual indicators, such as incandescent lamps and Light Emitting Diodes (LEDs), to expedite the performance of this task. Yet, these prior efforts have met with limited success because they typically involve a modification of the design parameters of the original system. In turn, this causes adverse impacts on design load, and impairs the electrical performance and/or efficiency of various components within the modified system. Moreover, these efforts are too costly or too complicated to achieve widespread acceptance.

The above-mentioned inventors have routinely taken one of the following general approaches. As a first approach, U.S. Pat. No. 5,739,737 uses an intrusive effort that permanently connects a visual indicator 18 in parallel across the leads 24 of each EPD in a service panel. This is accomplished by insertion of an entire liner, individual plug-in(s), or similar change to, or within, the existing service panel. This patent will not work successfully if there is a high resistance in the electrical circuit. This approach is depicted in my FIG. 1a wherein circuit 10 is provided between leads 24 that contains resistor 11 and LED 18. Said circuit will essentially bypass current flow around EPD 22 when it fails to perform its intended function of moderating current flow from the power source 14 across the EPD to the electrical load 16. The leads 24 are remote from the terminals 20 of the EPD. Optionally, a simple switch may be incorporated into FIG. 1 between the power source 14 and the power side of lead 24.

FIG. 1b presents a second approach, as disclosed in U.S. Pat. No. 5,701,118, that employs a hand-held, U-shaped tester 12. This tester includes a resistor 13 and a visual indicator 18 which are temporarily connected across the leads 24 of said EPD in a parallel manner. This is graphically shown within said figure wherein the tester probes are depicted as arrows contacting the leads 24 of the EPD 22 in close proximity to the respective terminals 20. A failed EPD will thereby be detected as the current flow is rerouted across the probes causing illumination of the visual indicator. This approach is time consuming, is labor intensive, and will not provide a continuous monitoring of every EPD-protected circuit in the service panel. It is also very difficult for this patent to successfully function if there is high resistance within the circuit of 5,000 ohms or more.

In a third approach, U.S. Pat. No. 4,281,322 utilizes a testing device 26 for the detection of blown automotive fuses in a motor vehicle. A plurality of electrical circuits are protected therein by a multiplicity of EPDs (F₁-F₇) which are positioned between a common power source 1 and electrical loads (L₁-L₇). The cathode end of each LED (D₁-D₇) is linked to its respective EPD, and the anode end is directly connected to ground through a manual switch 5. When manually closed, this switch stops the current flow to a particular electrical load and redirects it to ground through the LED. In routine operation, the closing of this switch causes the LED associated with a particular EPD to illuminate if the EPD is intact. If said fuse is blown, the LED will not illuminate. This approach is depicted herein by FIG. 2.

None of the prior inventors disclose the many advantages and benefits of my claimed invention; nor do they teach or suggest my approach or inventive elements. Moreover, the efforts by others have undesirably modified the initial design parameters for factory components and loads of each system.

It is therefore an object of the claimed invention to provide a permanent, visual status indicator within an electrical circuit which provides the appropriate circuitry for causing the indicator to continuously light whenever the EPD is intact and performing its intended function. It is another object to furnish an indicator with appropriate circuitry to cause the indicator to not be illuminated when the EPD has blown or failed. Such an illumination arrangement is useful for the quick and easy verification of electrical system integrity by minimal effort. It is a separate object of this invention to introduce such an indicator that may be used as an original equipment item or retrofitted to an existing system.

These and other objects, features, and advantages of this invention will be apparent to those skilled in the relevant arts upon a full reading of this specification and the appended claims which explain and define the aspects and principals of this invention.

### BRIEF DESCRIPTION OF THE DRAWINGS

FIG. 1a is a diagram of a circuit previously used in the prior art as discussed, supra, in Paragraph [0008].

FIG. 1b is a circuit diagram previously utilized in the art as disclosed above in Paragraph [0009].

FIG. 2 is a circuit diagram of the prior art as described in above paragraph [0010].

FIG. 3 is a simple diagram of my indicator circuit.

FIG. 4 is a plan view of a circuit assembly previously used in the art including, in series, a power source, an electrical protection device, an electrical load, and a ground. Arrows therein depict current flow through said circuit assembly from power source to ground.

FIG. 5 is a circuit assembly, similar to that of FIG. 4, of my indicator circuit in operation. Arrows show current flow therein.

### DETAILED DESCRIPTION

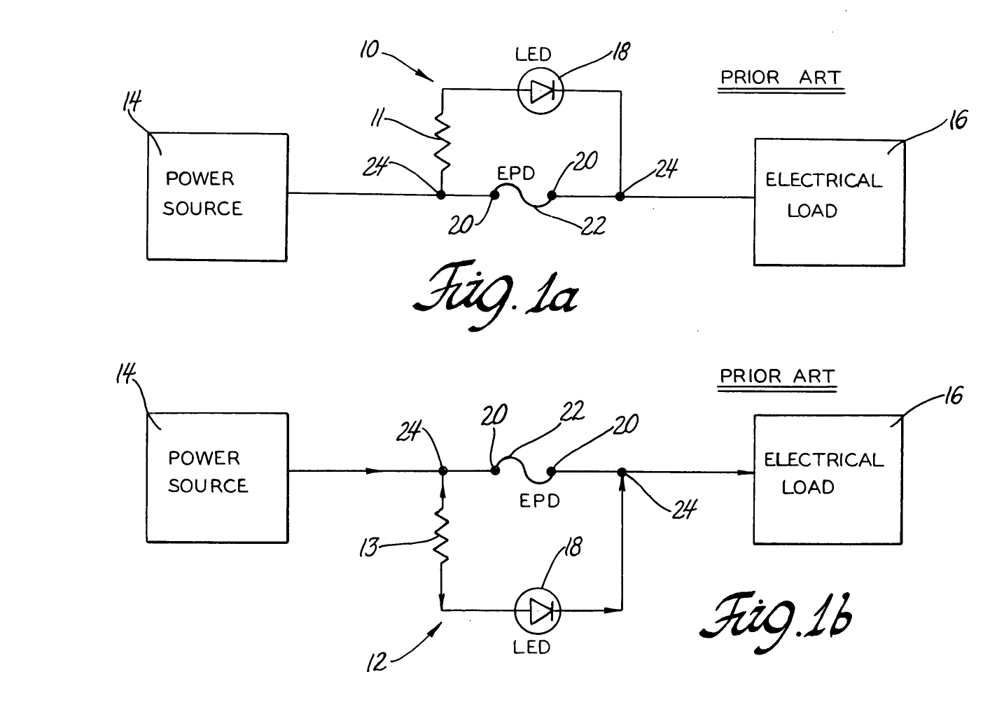

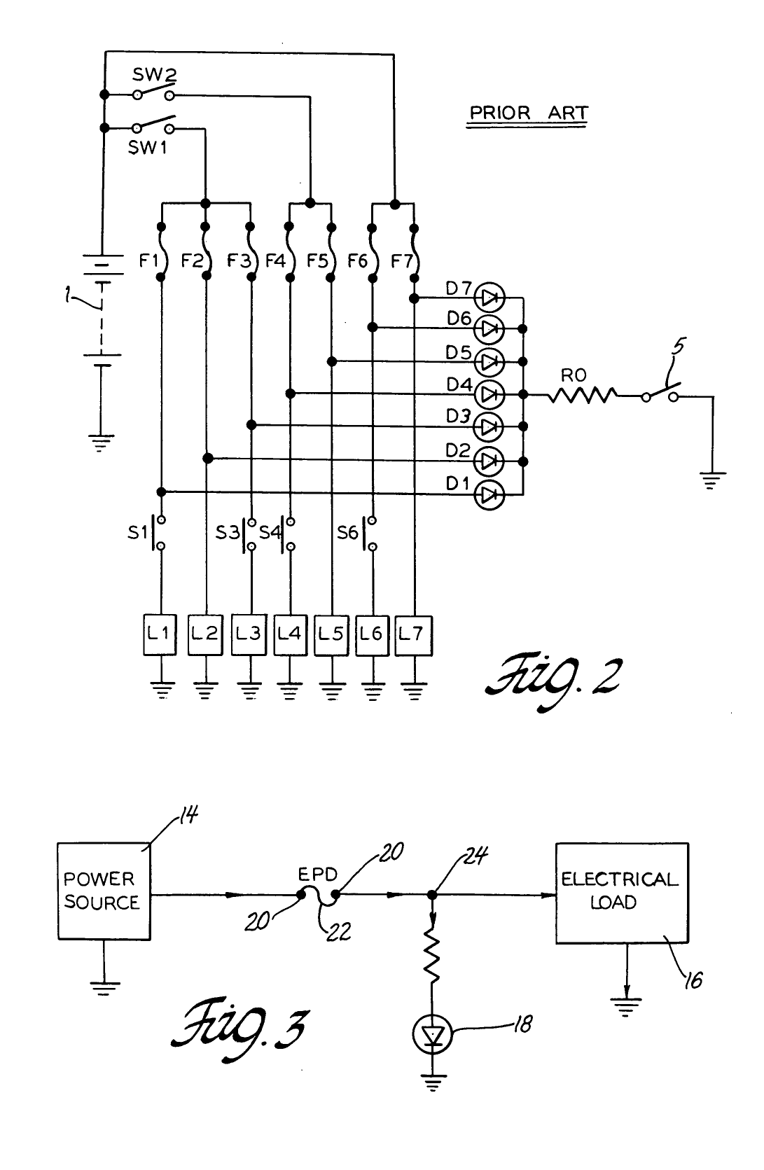

FIGS. 1 and 2 have been described before as prior art and further discussion is not made for the sake of brevity. FIG. 3 is a diagram of an indicator circuit of this invention that employs common reference numerals for the sake of consistency. Like FIGS. 1-2, my circuit has an EPD 22 that has been positioned between a power source 14 and an electrical load 16. If desired, a manual switch for circuit activation could be incorporated therein between said power source and the terminal 20 on the power side of the EPD. The anode of the EPD is electrically connected by conventional wiring to the power source, and its cathode is similarly connected to the electrical load via terminal 20 on the load side. At lead 24, positioned between EPD cathode terminal 20 and the load 16, my indicator circuit comprises a separate wiring of a series resistor R₃ and a LED 18 that are electrically connected to ground, in that order. Arrows within FIG. 3 depict the current path from the power source 14, through the EPD 22, to lead 24, and ultimately to the ground through electrical load 16. If EPD 22 fails, then the current path to lead 24 would open and the electrical load would cease to function. This failure would cause my LED 18 to not be illuminated and would simultaneously indicate that the EPD had either failed or needed to be reset.

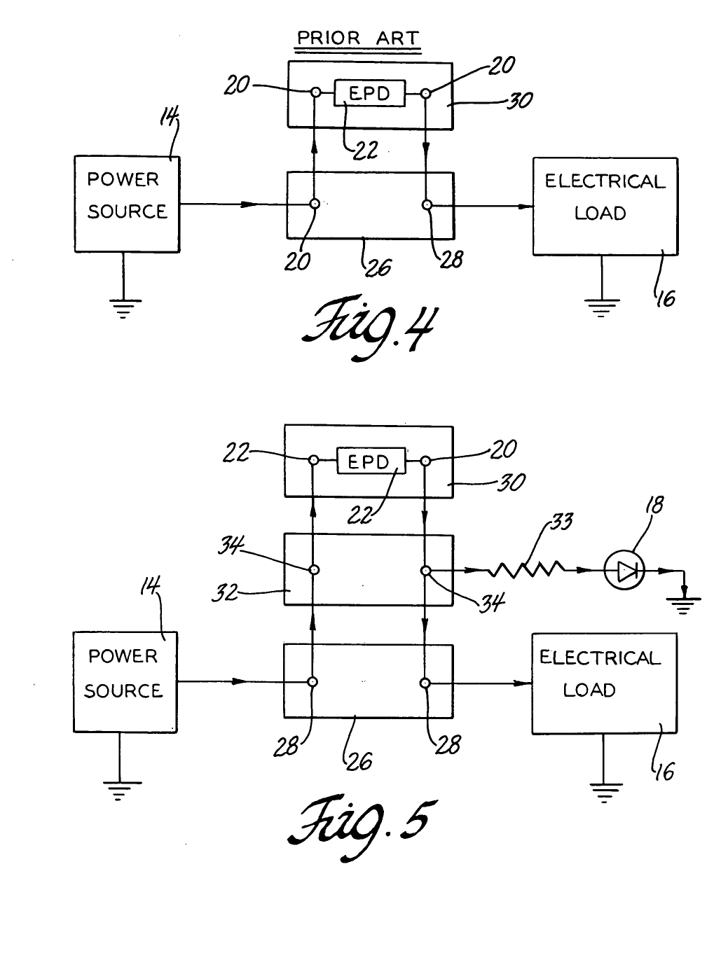

FIG. 4 is a diagrammatical depiction of a basic circuit assembly of the prior art that comprises a power source 14, a panel receptor 26, an EPD assembly 30, an electrical load 16, and a ground. For ease of assembly, the panel receptor 26 bears circuit connectors 28 that connect to EPD terminals 20 by any means of engineering choice. In turn, the EPD assembly 30 carries thereon EPD 22 and EPD terminals 20 which receive the circuit connectors 28. Arrows within FIG. 4 indicate the current flow therein. Again, a manual switch could be optionally included between the power source and the EPD.

FIG. 5 is a simple diagrammatical depiction of the circuit assembly of FIG. 4 including a structural adapter 32 incorporating an indicator circuit of this invention. Said adapter has dual connectors 34 that connect to the circuit connectors 28 of panel connector 26 and to the EPD terminals 20 of EPD assembly 30. Current flow therein is again indicated by arrows. Extending to the right from right-side dual connector 34 of structural adapter 32 is my monitoring circuit comprised of a series resistor R₃, a LED 18, and a ground. Accordingly, the LED 18 of my circuit is always lit if the EPD 22 is intact and functioning in its normal manner. If the EPD fails, then LED 18 will not be illuminated indicating the lack of current flow due to the loss of electrical load. Thereby, I do provide herein a continuous visual indicator for the quick and convenient determination of the status of an EPD-protected electrical circuit.

I wish it understood that I do not desire to be limited to the exact details of construction or method shown herein since obvious modifications will occur to those skilled in the relevant arts without departing from the spirit and scope of the following claims.

1. An indicator circuit for continuously verifying status of an electrical protection device, said device being energized by a power source and series connected between said power source and an electrical load to thereby form an electrical circuit, wherein said indicator circuit comprises a series resistor, a current responsive light emitting diode, and a ground, which are series arranged in that order and electrically connected to said formed electrical circuit at a junction between said electrical protection device and said electrical load.

2. The circuit of claim 1 wherein said power source has alternating current.

3. The circuit of claim 1 wherein said power source has direct current.

4. The circuit of claim 1 wherein said light emitting diode is provided sufficient current to emit visible light by preselection of said resistor based upon voltage of the power source.

5. The circuit of claim 1 wherein said light emitting diode is continuously illuminated if the electric protection device is intact and performing its intended function.

6. The circuit of claim 1 wherein said light emitting diode is not continuously illuminated if the electric protection device is open and not performing its intended function.

7. The circuit of claim 1 which does not modify the initial design parameters for the electrical load within the electrical circuit.

8. A complex electrical system comprised of a multiplicity of status indicator circuits of claim 1 for electrical circuits of industrial sites, homes, businesses, and ground, air, and water transports.

9. An indicator circuit for continuously monitoring status of an electrical circuit having an electrical protection device therein to perform protective functions, comprises:
a. said electrical protection device being series connected between a power source and at least one electrical load;
b. said indicator circuit having an electrical interconnection to said electrical circuit at a junction between said electrical protection device and said load; and
c. said indicator circuit including a resistor, a light emitting diode, and a permanent ground in series connection so current will continuously pass through said electrical circuit from the power source, to electrical protection device, to load, and simultaneously to said indicator circuit via said resistor, light emitting diode, and ground causing said diode to illuminate which will signal that said electrical protection device is intact and performing its intended function.
